(19) United States
(12) Patent Application Publication
(10) Pub. No.: US 2018/0307852 A1
(43) Pub. Date: Oct. 25, 2018

(54) SYSTEM AND METHOD FOR DATA SECURITY

(71) Applicant: Xiaolin ZHANG, Charlotte, NC (US)

(72) Inventor: Xiaolin ZHANG, Charlotte, NC (US)

(21) Appl. No.: 16/024,782

(22) Filed: Jun. 30, 2018

Related U.S. Application Data
(63) Continuation of application No. PCT/US16/69128, filed on Dec. 29, 2016.
(60) Provisional application No. 62/273,310, filed on Dec. 30, 2015.

(51) Int. Cl. G06F 21/62; H04L 29/06; G06F 17/30

(52) U.S. Cl. CPC G06F 21/6209; G06F 17/30109; H04L 63/04

(57) ABSTRACT

A system of securely sharing data includes first and second computers connected to a network and first and second non-transitory computer-readable media. Each computer includes a respective processor and network controller for transmitting and receiving a signature file and a data file across the network. The computer-readable media are each connected to a respective processor. Each computer-readable media stores certification instructions that, when executed, perform the steps of a certification process on the signature and data files. The certification process includes utilizing the first computer and certification instructions to create and transmit, to the second computer, a signature file related to the data file, and utilizing the second computer and certification instructions to receive and analyze the signature file to certify the data file for processing. The signature file includes objective meta-data based on information in the data file, specification data regarding executable instructions in the data file, or both.

### CROSS-REFERENCE TO RELATED APPLICATION

The present application is a U.S. continuation patent application of, and claims priority under 35 U.S.C. § 120 to, International Application No. PCT/US2016/069128, filed Dec. 29, 2016, designating the U.S., and entitled “SYSTEM AND METHOD FOR DATA SECURITY,” which '128 application published as WO 2017/117357 A1 on Jul. 6, 2017, which '128 application and the application publication thereof are each expressly incorporated by reference herein in their entirety, and which '128 application, for purposes of the United States, is a U.S. nonprovisional patent application of, and claims priority under 35 U.S.C. § 119(e) to, U.S. provisional patent application Ser. No. 62/273,310, filed Dec. 30, 2015 and entitled “SYSTEM AND METHOD FOR DATA SECURITY,” which '310 application is incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

### Field of the Present Invention

The present invention relates generally to secure techniques for transmitting data across a network, and more particularly, to techniques for transmitting data across a network in a secure system including certified components sharing a data file with a respective signature file confirming user authorization and data verification.

### BACKGROUND

Electronic communications are the prevalent systems for sharing information and the fastest growing information processing sectors in use across the world today. Securing these kinds of transmissions is an industry that, while growing at exponential paces, continues to improve on the basis of traditional hardware and data processing techniques. Security systems applied to data transmission in today's environment predominantly include hardware programmed to deny access to other hardware components (e.g., firewalls), software that monitors activity and searches for malfeasance (e.g. virus protection), or encryption techniques that encode data prior to sending the data to a destination qualified to decrypt it (i.e., passwords, keys, security data exchanges).

Current information systems manipulate data as the basic elements of a security system, and this technique is fundamentally unsecure and un-securable because once an individual has intercepted data, whether secured, encoded, or otherwise, that person has possession of the data. In data systems, the old theory that “possession=ownership” applies. In a chain of custody of data users, the system participants have no way to determine if a prior data possessor is authentic or if that prior possessor simply intercepted the data and manipulated the security to appear authentic. Once a bad actor has possession of a certain data file, within the data itself, there is no way to tell the characteristics of the data like its ownership, type, time stamp, expiration etc. In particular, there is no way to distinguish any piece of data versus its exact copy. All these lead to the fundamental security loophole of all the currently existing information systems, just like a society that exclusively uses cash for all commerce.

One problem with each of these kinds of systems is that they all include discrete, man-made security access barriers that can be compromised by decoding, identifying passwords, or tricking hardware with fake credentials. After all, systems that are made with separate, discrete security algorithms are all still just electronics with inherent vulnerabilities. A need exists in the art of secure data transmission that applies security tactics on a more fundamental basis to data transmissions. In other words, the field of secure data analysis needs a security mechanism that ties security features of a system directly to the data being transmitted as an unbreakable atomic entity while keeping security features and data on two separate and independent dimensions such that the security features and data are stored, transmitted and processed by separate hardware and software with the signature files non-addressable to any current hardware or software.

### SUMMARY OF THE PRESENT INVENTION

Broadly defined, the present invention according to one aspect is a system of sharing secure data across a network, including: at least first and second computers connected to a network, each including a respective processor and a respective network controller for transmitting and receiving a signature file and a data file across the network; and first and second non-transitory computer-readable media, the first non-transitory computer-readable media being connected to the processor in the first computer and the second non-transitory computer-readable media being connected to the processor in the second computer, wherein each non-transitory computer-readable media stores certification instructions on the respective first and second computers that when executed by the respective processor, performs the steps of a certification process on the signature file and the data file, wherein the certification process includes: utilizing the first computer and the certification instructions on the first non-transitory computer readable media, creating and transmitting, to the second computer, a signature file related to the data file, the signature file comprising objective meta-data based on information in the data file, specification data regarding executable instructions in the data file, or both, and utilizing the second computer and certification instructions on the second non-transitory computer readable media, receiving and analyzing the signature file to certify the data file for processing at the second computer.

In a feature of this aspect, the certification process further includes a step of transmitting a second computer signature file from the second computer to the first computer.

In another feature of this aspect, the transmitting step occurs during a handshake operation between said first computer and said second computer.

In another feature of this aspect, the step of creating a signature file includes a step of identifying, by the first computer, hardware components that are connected to the first computer. In further features, the step of identifying hardware components includes identifying hardware components previously certified for use with the first computer; and/or the step of identifying hardware components includes confirming previously certified components upon booting the first computer.

In another feature of this aspect, the objective meta-data of the signature file is determined from objectively identifiable properties of the data file. In further features, the objective meta-data is selected from the group consisting of transmission channel address, data channel communications format, file size, file type, font content, character count, page count, creation date, creation time, last access date, last access time, expiration data, originating computer properties, a checksum, edit history, transmission timing, origination ownership, transfer of ownership, rights to the file, reading rights, change rights, copying rights, and forwarding rights; and/or the originating computer properties comprise hardware specifications for the first computer.

In another feature of this aspect, the system further includes a third party computer communicating with the first and second non-transitory computer-readable media and updating the certifying instructions thereon.

In another feature of this aspect, the data file is an executable file and the signature file comprises execution specification data regarding the data file.

In another feature of this aspect, the execution specification data in the signature file instructs the second computer in regard to applications and interfaces that the data file will access.

In another feature of this aspect, the network controllers direct the signature file to the respective non-transitory computer-readable media that stores the certification instructions.

In another feature of this aspect, the signature file is addressable only by the certification instructions.

Broadly defined, the present invention according to another aspect is a method of securely sharing a data file between computers connected to a network, the method including: storing first certification instructions on a non-transitory computer readable medium on a first computer and second certification instructions on a non-transitory computer readable medium on a second computer; utilizing the first computer to execute the first certification instructions to create a signature file for the data file, the signature file including objective meta-data based on information in the data file, specification data regarding executable instructions in the data file, or both; transmitting the signature file across a network from the first computer to a second computer; transmitting the data file across the network from the first computer to the second computer; and utilizing the second computer to execute the second certification instructions to analyze the signature file, as received at the second computer, to certify the data file for processing at the second computer.

In a feature of this aspect, the method further includes a step of transmitting a second computer signature file from the second computer to the first computer.

In another feature of this aspect, the transmitting step occurs during a handshake operation between said first computer and said second computer.

In another feature of this aspect, the signature file and the data file are separate files stored in distinct locations in the non-transitory computer readable medium on the first computer.

In another feature of this aspect, wherein the signature file and the data file are transmitted over the network independently from one another.

In another feature of this aspect, wherein the step of utilizing the first computer to execute the first certification instructions to create a signature file for the data file includes identifying hardware components connected to the first computer. In further features, the step of identifying hardware components includes identifying hardware components previously certified for use with the first computer; and/or the step of identifying hardware components includes confirming previously certified components upon booting the first computer.

In another feature of this aspect, utilizing the second computer to execute the second certification instructions to analyze the signature file includes checking content of the signature file against data file properties. In a further feature, the signature file is analyzed, and the data file properties are checked, in real time as the second computer processes the data file.

In another feature of this aspect, the data file is an executable file, wherein the signature file comprises execution specification data regarding the data file, and wherein the execution specification data includes instructions for allocating resources utilized by the data file at the second computer.

In another feature of this aspect, the method further includes a step of assigning a public signature to a data file that exhibits a mismatch with a respective signature file.

In another feature of this aspect, the method further includes a step of timing out a certification checking procedure in which a data file matching a received signature file has not been received within a preset time limit.

In another feature of this aspect, content of the signature file is integral with and based on content of the data file, data file physical properties, and data file originating hardware.

In another feature of this aspect, the signature file is addressable only by the certification instructions and is identifiable by the network controller for routing.

Broadly defined, the present invention according to another aspect is a non-transitory computer-readable medium stored on a computer for sharing a secure data file between first and second computers connected to a network that when executed on a processor, that performs the steps of: creating an outgoing signature file for the data file, the signature file including objective meta-data based on information in the data file, specification data regarding executable instructions in the data file, or both; analyzing an incoming signature file to certify the data file for processing at the computer upon checking the content of the signature file against properties of the data file; and permitting the computer to send, receive, or process the data file as a certified data file verified by the content of the signature file.

In a feature of this aspect, creating the outgoing signature file comprises populating the signature file with properties of the data file, properties of a computer transmitting the data file across the network, or both.

In another feature of this aspect, creating the outgoing signature file comprises populating the signature file with data regarding transmission infrastructure used to send the data file across the network.

In another feature of this aspect, the data file is an executable file, and wherein the signature file comprises function descriptions, applications to be accessed, user rights, inputs, or outputs of the executable file.

In another feature of this aspect, the non-transitory computer-readable medium stored on a computer further includes program instructions stored thereon for randomly selecting transmission channels for the signature file and the data file and recording the selected transmission channels in the signature file.

In another feature of this aspect, the non-transitory computer-readable medium stored on a computer further includes program instructions stored thereon for assigning a public signature file to a data file transmitted by an originating computer without creating an outgoing signature file.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram of an architecture for a system implementing a signed-data communication (SDC) protocol in accordance with one or more preferred embodiments of the present invention; and

FIG. 2 is a block diagram of one of the computing devices of FIG. 1, including the certified hardware.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiment(s) is merely exemplary in nature and is in no way intended to limit the invention, its application, or uses.

The security mechanisms, protocols, methodologies, computing devices, and/or systems disclosed herein introduce and/or utilize the concept of signed-data in a new context. For purposes herein, and without limiting the invention to any one embodiment, signed-data may be understood to refer to content data, which may include information of any or all kinds, plus signature data that is integrally related to the content data, all being transmitted from one point to another in a network. In other words, a signature file of signature data can be transmitted with a content data file that includes the content data at issue. Signature data and content data are terms used herein for the convenience of differentiating data files for description purposes but are not limited to any kind of particular data. For instance, content data file can be any kind of data file that includes executable files, software instructions, graphics, text, code, encrypted data, or any kind of data susceptible of sharing in any way. Similarly, the signature file may be created and stored with information, i.e., data, that has a defined relationship to the data in the content file. Without limiting the invention to any particular embodiment, signature data may include, but is not limited to, the identity or characteristics of an authorized owner for the content data, content data file type, granted users and rights, functions and subroutines that an executable content data file is expected to use, interfaces that the content data file is expected to access, or numerous fixed properties of a content data file (e.g., without limitation, font, number of characters, number of lines, last access date and time, time stamp, size, checksum, etc).

Without limiting the invention in any way, the signed-data communication (SDC) system and protocol disclosed herein tie the signature file and the content data file together in a relationship such that, in a sense, the two files “share DNA.” One goal of the invention is to disclose a secure data transmission and sharing system that ties a signature file and a content data file together in way that is similar to molecules sharing atomic structures. The overall system (i.e., the molecule) can operate independently, but in a micro view, the molecule includes atoms that have shared bonds. The shared bonds are identifiable, repeatable, and expected in every version of the molecule. In this analogy, the signature file and the content data file are atomic components of the system that are bonded in a defined relationship that shares sub-molecular elements (the identifying components discussed in the preceding paragraph above).

In one embodiment, accomplishing the SDC system and protocol of this disclosure utilizes an overall certification process that can be managed by a third party certifier. The detailed roles of a third party certifier can be adjusted depending upon the needs at hand. For purposes of description only, and without limiting the invention to any one embodiment, the third party certifier can be used as a clearinghouse to identify, certify, and document hardware components that participate in a certified SDC system. In other words, when participant users of the SDC protocol desire to operate within a certified SDC system of certified hardware, certified software, and certified data sharing, the third party certifier oversees the construction of every component that will form a node on a certified network of users sharing content data files and signature files. The third party certifier is available to certify individual computer components (e.g., transistors, switches, etc.), overall components (e.g., keyboards, hard drives, monitors, and peripherals that will comprise a node on the network), and groups of nodes forming subsystems that routinely exchange information across the network (e.g., bank servers and point of sale card readers). In at least some embodiments, the third party certifier is authorized to deem connected and certified nodes (i.e., hardware on a network) to be “certified” because the node's computerized parts were originally certified prior to installation. In a certified system of participating nodes on a network, all of which are certified by the third party certifier, the system implements a signed-data communications (SDC) protocol.

In at least some embodiments, each participant in a certified system possesses computerized hardware at a node on the network. The participating computerized hardware incorporates a chip or other hardware component bearing computer readable instructions and software to manage the certification process at that node. The chip at each node, therefore, ensures that certified data sharing occurs according to an agreed SDC protocol set forth by the third party certifier. In one embodiment, the third party certifier programs the certifying chip at a node to operate as or in conjunction with a network controller to direct data traffic to the appropriate components of the computer hardware at that node. Without the presence of the certified chip, the node and all components, files, and software at that node are deemed to be “public.” A public node cannot access or share certified data, such as the above described content data file and signature data file.

A signed-data chip (wherein “chip” is the common word for computer readable memory in a computerized hardware component) accomplishes the following general features:
1) Create a signature file at a certified node on the network, with the node including hardware or software provided by a manufacturer and certified by the third party certifier;
2) Implement the algorithm and computer program instructions to conduct the signature file creation and overall certified enforcement protocol;
3) Check the integrity of the equipment on a certified node on power-on or boot up;
4) Enforce the integrity of signed-data during operations, specifically the certified chip at a node exclusively processes the signatures of the signed-data according to signature algebra by making it un-addressable by any other hardware;
5) Enforce the functionality and interfaces of the certified entity against any misbehavior; and/or
6) Communicate with the third party certifier to centrally track and manage the overall security process described herein.

As a general description, the above noted “chip” is a non-transitory computer readable medium bearing software or coded instructions that can be implemented by a processor at a node. The signature certifying computer readable medium, or “chip,” at a node may have embedded modules of software that implement signature verification for a computer or may include addressing and certification numbering techniques that allow the chip to confirm a certified node and the data processing occurring at that node.

In the event that a network includes non-certified equipment or nodes, that non-certified equipment is assigned by the third party certifier or by any certified component as a “public system.” The certified system described herein assigns a public signature to any component accessible on a network shared with certified components. Once a network node has been deemed public and not certified, any data going to that node or passing through that node is deemed public. A public designation cannot be reversed in any way.

It is also worth noting that if a node on a network has a hardware change that has not been certified by the third party certifier, then that node is deemed public. The hardware change will be recognizable by the certifying chip at that node when the hardware is booted, and the change in status reported to the overall third party certifier who tracks all certified components of all certified nodes. On boot, all parts of the system report to the certification chip as specified by each component's signature, and the certification chip checks the entirety of the components at that node, device or application within itself for any discrepancy. The chip invalidates the certification of that node on the system if any non-certified changes are found. In one embodiment, any certified system, device or application connected to other certified participants can be considered a certified node or sub-system. Any connected “public” entity, makes the whole node or sub-system “public” with an assigned public address. The system described herein includes the concept that a third party certifier tracks (i.e., in a database or other management tool) all certified components of all certified participants. The goal is to certify and track, via a third party certifier, all components, both hardware and software, for each component in a system.

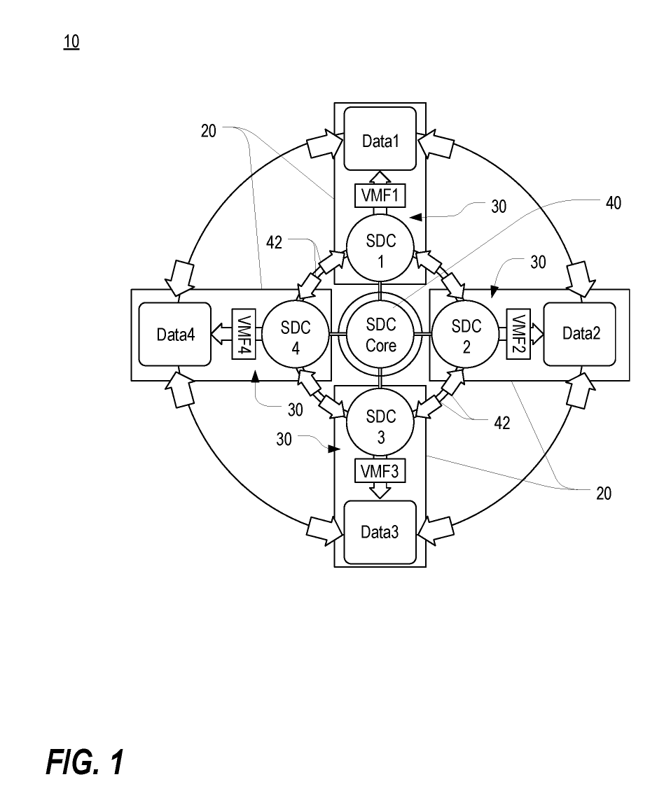

FIG. 1 is a block diagram of an architecture for a system 10 implementing a signed-data communication (SDC) protocol in accordance with one or more preferred embodiments of the present invention. As shown therein, the system 10 includes two or more computing devices 20 (four being shown), each of which incorporates specialized certified hardware 30 therein. The computing devices 20 are connected across one or more computer networks, and the certified hardware 30 in each system is connected to a certified SDC core 40.

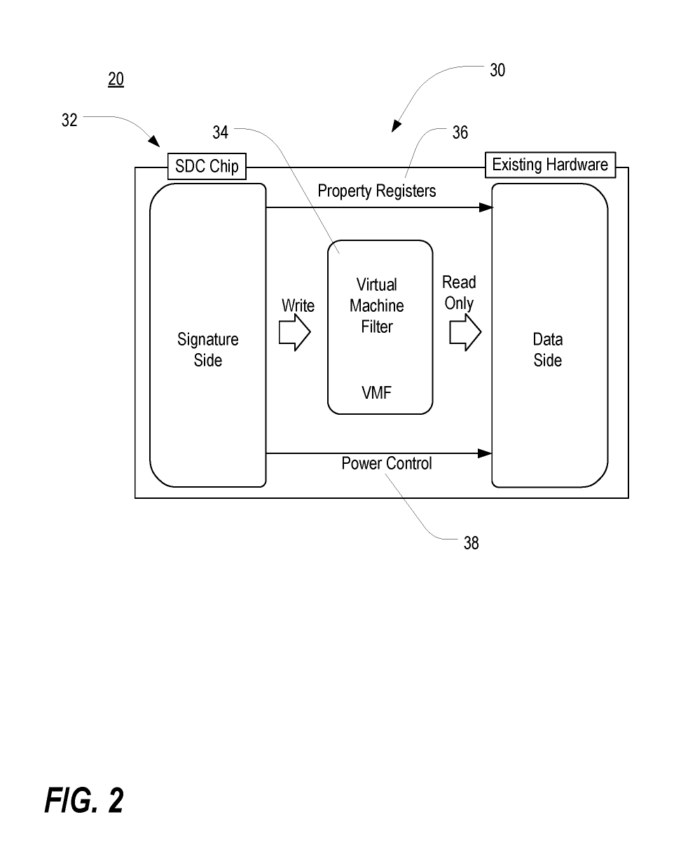

FIG. 2 is a block diagram of one of the computing devices 20 of FIG. 1, including the certified hardware 30. The certified hardware 30 includes, in addition to the existing or conventional computer device hardware, a signed-data communication (SDC) chip 32, a virtual machine filter (VMF) 34, one or more property registers 36, and power control 38. The VMF 34 is preferably implemented using directional memory. A VMF is generated by the SDC Chip 32 for each certified hardware and software communication. All certified hardware and software accesses are through the VMF 34. The SDC chip 32 stays powered on constantly. On data side boot up, the SDC chip 32 checks the property registers 36 for the data side to make sure no change has been made before the data side is allowed to boot up. This check is also done during regular operation. The locations and the values of the registers 36 are provided by the manufacturer of the hardware as part of its signature file and confirmed during the certification process described above.

All of the SDC chips 32 in an SDC system 10 are connected to each other and to the core 40. The connections 42 are through channels that are separate from the data side connection. The SDC chips 32 stay running continuously in a manner similar to the subconscious part of a human brain. In a situation where an SDC chip 32 loses power or is un-operational and thus requires powering on, it must do a self-check, a peer check with the other SDC chips in the system 10, and a check with the core 40.

Overall, the SDC protocol and SDC system 10 described herein achieves a level of data content security by creating a signature file that is integral with, based on, and predictive of a content data file to be shared among network participants. In some embodiments, the signature file may need to be customized for additional security concerns. In this event, the signature file may need a separately transmitted nested signature file (i.e., a signature file for the signature file). The point here is that the signature file and content data file have been described as two dimensional in that the files are of a single origin but are transmitted in separate axes of communication. That same origin, however, may be the origin of a “signature file for the signature file” in which a nested signature file is part of the secure transmission scheme. The nested signature files can create multi-dimensional security mechanisms from the same origin data. In one non-limiting example of the multi-dimensional security mechanism, the signature file and the content data file are transmitted along with a nested signature file that may include meta-data for the signature file. In the geometric example/analogy of a multi-dimensional system emanating from a single origin (in which the “origin” would, in reality, be a single set of content data), the nested signature file would be akin to a second (mathematical) derivative or other function of the first signature file. The concept herein implies that the various signature files and content data files are descriptive of one another in at least one aspect. Further details of the signature file, the content data file, and the overall system of this invention are set forth below.

In at least some embodiments, the SDC system 10 described herein includes at least first and second computers connected to a network as participating nodes and having respective processors and respective network controllers for transmitting and receiving a signature file and a data file across the network. Each computer has first and second non-transitory computer-readable media connected to the respective processors in the computers and storing certification instructions on the respective first and second computers that when executed by the respective processors, perform the steps of a certification process on the signature file and the data file, wherein the certification process comprises: a) utilizing the first computer and the certification instructions on the first computer readable media, creating and transmitting, to the second computer, a signature file corresponding to the data file, the signature file comprising objective meta-data based on information in the data file, specification data regarding executable instructions in the data file, or both; and b) utilizing the second computer and additional instructions on the second computer readable media, receiving and analyzing the signature file to certify the data file for processing at the second computer.

In at least some embodiments, transmission of the signature files occurs during a handshake operation across the network. The computer readable media, or chip, at each node directs the signature file to the proper processors to ensure that the chip knows exactly what kind of data content file to expect and what that data content file will do or include. In this way, the chip sees the signature file first. Given that the signature file is based on integral information within the data content file, the chip then understands exactly what to expect in terms of the content data file. If the content data file, received separately, does not conform to the expectations set forth in the signature file, then the chip alerts the hardware at that certified node of a problem and stops the data processing.

As described above, the certified system includes the proper chip, i.e., non-transitory computer readable medium, and software stored thereon to analyze a signature file received on a particular channel or addressed in an identifiable way such that the certified chip is the only component that can recognize the signature file as such. The signature file is entirely non-addressable to any other hardware or software other than the third party certifier's chip installed at a node. The chip then analyzes the signature file, which can include meta-data, descriptors, processes to be run, or other identifiers for an associated data content file expected to arrive at the same node as the signature file. Any unexpected aspect of the data content file arriving or operating as an executable at a certified node halts all operations until resolved.

The SDC protocol may be considered as a series of three stages of communications among certified nodes on a network: 1) signature level communication set up at creation: pre-settings, 2) signature handshake with re-confirmation according to the set-up at stage 1 (wherein a signature is generated using pre-settings (channel, format, etc) and specific data (owner, type, expiration date, rights, size, checksum, fingerprint etc)), and 3) data communication according to resultant expectations at stage 2.

In some embodiments, one certified node can be a dominant player in the exchange of data by establishing the pre-sets such as logins, copy/read/write authorizations for a file, the channels and timing protocols for files, and originating the signature handshake to another node on the network. Of course, as permissions allow, certain formats, addresses, and channel assignments may change.

In other embodiments, the two nodes may be equal certified participants that utilize preset public channel formats but override certain parameters for communications in a certified system with custom settings agreed by two certified network nodes.

In any certified system, if a certain node is designated as a receiving node, the receiver only listens on the signature channels first for possible initiation of signature handshake. Unexpected data channel communications are ignored. Only expected data-channel data is received and evaluated.

The following description is indicative of one example communication method in one preferred embodiment of the SDC system and protocol.

Step 0—Upon receipt of a communication, the receiver checks if the other node, operating as a sender, is signed-data certified. If not, a “public” communication version of the protocol, while if yes, then operation moves to step 1. (Basically, in the “public” version, a pre-defined “public” signature is assigned to the other side of communication.)

Step 1—The sender sends signature to the receiver. This involves the following rules or sub-steps. First, signature sent on any other channel than the pre-set channel is ignored. If the format and content of signature is not a match for the pre-settings, then the receiver ignores the signature. Alternatively, if the format and content match the pre-settings, then the receiver requests confirmation on the preset channel (possibly different) and format from the sender. Here, if confirmation is received, then the receiver moves to Step 2 (below), while if no confirmation occurs before timeout, then the receiver ignores the signature.

Step 2—The receiver effectively tells the sender to proceed to send the actual data to the receiver. This involves the following rules or sub-steps. First, if the data is not received before timeout, or if the data is received but does not match the signature, then the receiver stops the communication. However, if the data is received and matches the signature, then the receiver sends an acknowledgement to the sender and successfully finishes communication.

It is significant that the receiving node has access and understands the entire content of the signature file before even receiving the data content file. In this way, for static data content files, the receiving node can confirm in real time that the static data content file matches the signature file. The signature file includes descriptive meta-data that is taken from and integral with the proper content data file that should be received pursuant to the terms of the signature file. Any discrepancies in the description in the signature file versus the content of the content data file, and the problem is alerted to all participants and the process halted until resolved.

Similarly, if the content data file is an executable, the receiving node will have analyzed a signature file with information educating the receiving hardware as to what the executable file (i.e., content data file as an executable file) looks like, acts like, requires as inputs and outputs, and other run time features (subroutines to be called, interfaces to be accessed at the receiving node, hardware that the content data file will access and use, software that that the content data file will access and use). All of the executable file instructions will be monitored by the receiving node to ensure that each significant feature matches what was to be expected.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A system of securely sharing data across a network, comprising:
(a) at least first and second computers connected to a network, each including a respective processor and a respective network controller for transmitting and receiving a signature file and a data file across the network; and
(b) first and second non-transitory computer-readable media, the first non-transitory computer-readable media being connected to the processor in the first computer and the second non-transitory computer-readable media being connected to the processor in the second computer, wherein each non-transitory computer-readable media stores certification instructions on the respective first and second computers that when executed by the respective processor, performs the steps of a certification process on the signature file and the data file, wherein the certification process includes:
(i) utilizing the first computer and the certification instructions on the first non-transitory computer readable media, creating and transmitting, to the second computer, a signature file related to the data file, the signature file comprising objective meta-data based on information in the data file, specification data regarding executable instructions in the data file, or both, and
(ii) utilizing the second computer and certification instructions on the second non-transitory computer readable media, receiving and analyzing the signature file to certify the data file for processing at the second computer.

2. The system of claim 1, wherein the certification process further includes a step of transmitting a second computer signature file from the second computer to the first computer.

3. The system of claim 1, wherein the transmitting step occurs during a handshake operation between said first computer and said second computer.

4. The system of claim 1, wherein the step of creating a signature file includes a step of identifying, by the first computer, hardware components that are connected to the first computer.

5. The system of claim 4, wherein the step of identifying hardware components includes identifying hardware components previously certified for use with the first computer.

6. The system of claim 4, wherein the step of identifying hardware components includes confirming previously certified components upon booting the first computer.

7. The system of claim 1, wherein the objective meta-data of the signature file is determined from objectively identifiable properties of the data file.

8. The system of claim 7, wherein the objective meta-data is selected from the group consisting of transmission channel address, data channel communications format, file size, file type, font content, character count, page count, creation date, creation time, last access date, last access time, expiration data, originating computer properties, a checksum, edit history, transmission timing, origination ownership, transfer of ownership, rights to the file, reading rights, change rights, copying rights, and forwarding rights.

9. The system of claim 8, wherein the originating computer properties comprise hardware specifications for the first computer.

10. The system of claim 1, further comprising a third party computer communicating with the first and second non-transitory computer-readable media and updating the certifying instructions thereon.

11. The system of claim 1, wherein the data file is an executable file and the signature file comprises execution specification data regarding the data file.

12. The system of claim 1, wherein the execution specification data in the signature file instructs the second computer in regard to applications and interfaces that the data file will access.

13. The system of claim 1, wherein the network controllers direct the signature file to the respective non-transitory computer-readable media that stores the certification instructions.

14. The system of claim 1, wherein the signature file is addressable only by the certification instructions.

15. A method of securely sharing a data file between computers connected to a network, the method comprising:
(a) storing first certification instructions on a non-transitory computer readable medium on a first computer and second certification instructions on a non-transitory computer readable medium on a second computer;
(b) utilizing the first computer to execute the first certification instructions to create a signature file for the data file, the signature file including objective meta-data based on information in the data file, specification data regarding executable instructions in the data file, or both;
(c) transmitting the signature file across a network from the first computer to a second computer;
(d) transmitting the data file across the network from the first computer to the second computer; and
(e) utilizing the second computer to execute the second certification instructions to analyze the signature file, as received at the second computer, to certify the data file for processing at the second computer.

16. The method of claim 15, further comprising a step of transmitting a second computer signature file from the second computer to the first computer.

17. The method of claim 15, wherein the transmitting step occurs during a handshake operation between said first computer and said second computer.

18. The method of claim 15, wherein the signature file and the data file are separate files stored in distinct locations in the non-transitory computer readable medium on the first computer.

19. The method of claim 15, wherein the signature file and the data file are transmitted over the network independently from one another.

20. The method of claim 15, wherein the step of utilizing the first computer to execute the first certification instructions to create a signature file for the data file includes identifying hardware components connected to the first computer.

21. The method of claim 20, wherein the step of identifying hardware components includes identifying hardware components previously certified for use with the first computer.

22. The method of claim 20, wherein the step of identifying hardware components includes confirming previously certified components upon booting the first computer.

23. The method of claim 15, wherein utilizing the second computer to execute the second certification instructions to analyze the signature file includes checking content of the signature file against data file properties.

24. The method of claim 23 wherein the signature file is analyzed, and the data file properties are checked, in real time as the second computer processes the data file.

25. The method of claim 15, wherein the data file is an executable file, wherein the signature file comprises execution specification data regarding the data file, and wherein the execution specification data includes instructions for allocating resources utilized by the data file at the second computer.

26. The method of claim 15, further comprising a step of assigning a public signature to a data file that exhibits a mismatch with a respective signature file.

27. The method of claim 15, further comprising a step of timing out a certification checking procedure in which a data file matching a received signature file has not been received within a preset time limit.

28. The method of claim 15, wherein content of the signature file is integral with and based on content of the data file, data file physical properties, and data file originating hardware.

29. The method of claim 15, wherein the signature file is addressable only by the certification instructions and is identifiable by the network controller for routing.

30. A non-transitory computer-readable medium, stored on a computer for sharing a secure data file between first and second computers connected to a network, that when executed on a processor, performs the steps of:
(a) creating an outgoing signature file for the data file, the signature file including objective meta-data based on information in the data file, specification data regarding executable instructions in the data file, or both;
(b) analyzing an incoming signature file to certify the data file for processing at the computer upon checking the content of the signature file against properties of the data file; and
(c) permitting the computer to send, receive, or process the data file as a certified data file verified by the content of the signature file.

31. The non-transitory computer-readable medium of claim 30, wherein creating the outgoing signature file comprises populating the signature file with properties of the data file, properties of a computer transmitting the data file across the network, or both.

32. The non-transitory computer-readable medium of claim 30, wherein creating the outgoing signature file comprises populating the signature file with data regarding transmission infrastructure used to send the data file across the network.

33. The non-transitory computer-readable medium of claim 30, wherein the data file is an executable file, and wherein the signature file comprises function descriptions, applications to be accessed, user rights, inputs, or outputs of the executable file.

34. The non-transitory computer-readable medium of claim 30, further comprising program instructions stored thereon for randomly selecting transmission channels for the signature file and the data file and recording the selected transmission channels in the signature file.

35. The non-transitory computer-readable medium of claim 30, further comprising program instructions stored thereon for assigning a public signature file to a data file transmitted by an originating computer without creating an outgoing signature file.
